(19) United States
(12) Patent Application Publication
(10) Pub. No.: US 2006/0247363 A1
(43) Pub. Date: Nov. 2, 2006

(54) Polyamide molding material, molded articles that can be produced therefrom and the use thereof

(76) Inventors: Alwin Hermann Schwitzer, Domat/Ems (CH); Manfred Hewel, Domat/Ems (CH); Eduard Schmid, Bonaduz (CH); Ivano Laddona, Thusis (CH)

Correspondence Address: MARSHALL & MELHORN, FOUR SEAGATE, EIGHT FLOOR, TOLEDO, OH, 43604, US

(21) Appl. No.: 10/533,528

(22) PCT Filed: Oct. 31, 2003
(86) PCT No.: PCT/EP03/12131

§ 371 Date: Apr. 7, 2006

(30) Foreign Application Priority Data
Nov. 4, 2002 (DE) 102 51 294.9

(51) Int. Cl. C08K 3/04; C08L 77/00

(52) U.S. Cl. 524/495; 524/538

(57) ABSTRACT

The invention relates to a novel polyamide molding material for highly lustrous and rigid polyamide molded articles that contains a polyamide mixture consisting of a semicrystalline linear polyamide, a special branched graft polyamide, an amorphous polyamide, reinforcing substances as well as conventional additives.

The invention relates to reinforced polyamide moulding materials with improved processing behaviour, increased flowability, and moulded bodies produced therefrom with improved surface quality and improved mechanical properties, in particular in the conditioned state after moisture absorption. The moulding material according to the invention is suitable for producing moulded articles, in particular with large wall thicknesses, or other semi-finished goods or finished articles which can be produced for example by means of extrusion, extrusion blow-moulding, extrusion stretch blow moulding, pultrusion, injection moulding, micro-injection moulding, GIT-injection moulding, injection blow-moulding or other shaping techniques.

Reinforced polyamides play an increasing role in the field of commercial construction materials which, in addition to high rigidity, toughness and thermostability must show an optimal surface quality for uses in the visible applications. Fields of use are internal and external parts in the automotive industry and other transport fields, housing material for appliances and apparatus for telecommunications, consumer electronics, household appliances, mechanical engineering, the heating field and attachment parts for installations. Exterior parts, which are subjected to weathering, in addition require a corresponding stabilisation, in order to ensure the necessary function for a number of years.

The particular advantage of reinforced polyamides results in the extraordinarily good bond between the polymer matrix and reinforcing materials. As a result, high degrees of reinforcement are possible, which lead to highly rigid products which, because of the low melt viscosity of polyamides, are readily processible by injection moulding.

Disadvantages of reinforced polyamide moulding materials such as; for example, glass fibre reinforced polyamide 6 (PA6) are the sharp deterioration of the mechanical properties (rigidity, tensile strength) and the strong increase in the breaking elongation due to water absorption in the standard operating environment.

High proportions of reinforcing materials, such as for example glass fibres, carbon fibres or others, reduce the flowability in a rapidly solidifying, partially crystalline polymer matrix, for example during injection moulding processing, and lead to reduced surface quality. Therefore reinforced moulding materials made of partially crystalline polyamides (PA6, PA66, PA6T/66 etc.) lead to poor surfaces, in particular in the case of high reinforcement proportions and in the case of moulded articles with high wall thicknesses, due to the high melting temperature and a very high crystallisation rate. In these cases, it is attempted to keep the filling content low and to achieve the rigidity by means of ribbing.

It is known that the flowability of polymer melts can be increased and the solution viscosities/melt viscosities can be reduced by means of branched polymers. Branched polyamides for flow improvement are likewise known and their production can be effected via various ways.

Transparent polyamide mixtures are described in EP 1 120 443 A2, in which a branched polyamide component based on the transparent polyamide is used in order to improve flow. The resulting non-reinforced mixtures are more rigid but lower in notch-impact strength than the purely transparent polyamides. The branched polyamide is produced via a polyamine dendrimer. Transparent polyamides must be used as the basis of the mixtures and the mixtures must remain transparent.

EP 0 671 703 A1 also describes the production of branched, star-shaped polyamides from linear polyamides with dendrimers as branching agents for improving flow.

The production of star-shaped polyamides from lactams by means of a 2-stage process with a triazine derivative or a tri-functional amine as branching agent is described in EP 0 832 149-B1. The resulting star-shaped (3 arms) polyamides show a reduction in the melt and solution viscosity. Furthermore, the lactam polymerisation with the branching agents produces a mixture of low molecular, linear polyamides and branched polyamides.

The production of H-shaped polyamides from lactams or amino carboxylic acids with at least tri-functional amines (dendrimers) or tri-functional carboxylic acids as branching structures is known from DE 19 654 179 A1. The H-shaped polyamides show an improved flow behaviour with good mechanical properties. In this publication, only the production of the branched polyamides is referred to and no reinforced moulding materials are described.

Methods for producing branched graft polyamides (AB-type), which can be used as non-reinforced blend component or as thermoplastic adhesives, from diamines and dicarboxylic acids via pre-condensates, which appear to cross-link, or via a hydrolytic degradation of for example PA66 with polyamines as branching structure, are described in EP 1065 232 A2.

Furthermore, hydrolysis-stable, low viscous, branched polyamides are known from EP 1 065 236 A2 which are produced in a batch method from caprolactam and a polyamine. The obtained polyamides are used preferably as non-reinforced solvent- and fuel-resistant moulding materials.

Highly branched, hyper-branched polyamides/polyesters are presented in U.S. Pat. No. 5,480,994, which are mixed with semicrystalline or amorphous thermoplasts for molecular reinforcement.

In the above-cited state of the art however, no reinforced polyamide moulding materials with branched polyamides are described, and the effect of the branched polyamides on the flowability of the reinforced moulding materials and the mechanical properties, also after moisture absorption, and on the surface quality of moulded articles produced therefrom is not described.

WO 0 068 298 describes the production of highly branched, hyper-branched polyamides (PA6) which are similar to dendrimers and have short PA6 arms, of 2-10 caprolactam units per arm, as an additive in order to improve the melt flow of reinforced, thermoplastic moulding materials. The thus produced moulding materials are distinguished by a higher fracture strength and a higher Tg.

Reinforced polyamide moulding materials are also presented in EP 1099 727 A2. They comprise mixtures of thermoplastic polyamides with highly branched, so-called hyper-branched, polyether imides, which are obtained by polymerisation of 1-oxazolines. The moulding materials are distinguished by an improved flowability and a reduction in the crystalline portion.

The visual surface improvement of injection moulded articles is described in WO 0 196 474, in which linear partially crystalline polyamides are mixed with highly branched polyamide 6, with short polyamide 6 arms, and reinforcing materials to produce the moulding resin.

In this state of the art also, no solution for moulded bodies made of reinforced polyamide mixtures with an attractive surface quality and good mechanical properties after moisture absorption is given. Furthermore, the production methods of the branched polyamides for improving flow in the cited publications are generally very complex, with partly multi-stage processes, or they produce no defined structures, or the branching structures are very costly and bear no relation to their use.

It is therefore the object to discover polyamide moulding materials which have a high melt flowability with a high filling content and which show a high gloss on the moulded articles. The moulding materials should have in the dry and conditioned state as few differences as possible in the mechanical properties, the thermostabilities should be as high as possible while having moderate processing temperatures.

This object is achieved, with respect to the moulding material, by means of the features of claim 1 and, with respect to the moulded articles, also by the features of claim 15. The sub-claims reveal advantageous developments.

Surprisingly, it was found that, by means of the addition of branched, highly flowable graft polyamides, which are derived from linear semicrystalline polyamides to linear semicrystalline polyamides and amorphous polyamides, moulding materials are obtained, which, in the case of high reinforcement proportions, show high rigidity, a high tensile strength, a high tensile strength even after moisture absorption, and have high flowability of the melt or a low solution viscosity and moulded articles produced therefrom have a high surface quality.

What is essential in the case of the polyamide mixture A) is thereby not only that it is a combination of a semicrystalline linear polyamide a) with a branched graft polyamide b), but rather that the graft polyamide b) must fulfil specific conditions.

According to patent claim 1, the graft polyamide b1) is constructed from a styrene maleinimide basic structure unit of the general formula 1, 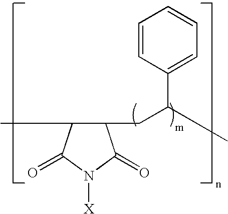
m standing for 1-5 and n for 3-15, the molecular weight of the basic structure unit being between 600 and 9000 g/mol and in that, at the position x, a polyamine acid chain was grafted on. A graft polyamide of this type is basically known in the state of the art. For this purpose and with respect to a thereto relating method for producing graft polyamides of this type, reference is made to EP 0 409 115 B1. Explicit reference is made to the disclosure content of this document. It is accordingly preferred if the styrene maleinimide basic structure unit of formula 1 is connected via imide bonds at x with the polyamine acid chains. It is most particularly preferred if the molecular weight then lies between 10,000 and 100,000 g/mol.

A further possibility resides in the fact that a graft polyamide b.2) is used, which was obtained by means of hydrolytic polymerisation from amino acids and/or lactams as basic building blocks, whereas preferably at least 50% by weight of the polymer molecules having more than one chain branch. During production, components which effect branching are added to the melt of the basic monomers in the following composition:
b.2.1) 5-150 μmol/g of the polymer of an at least tri-functional monomer comprising an amine or a carboxylic acid, and
b.2.2) 2-100 μmol/g of the polymer of an at least tri-functional monomer comprising a carboxylic acid, if b.2.1 is an amine, or comprising an amine, if b.2.1 is a carboxylic acid.
   If necessary also 5-450 μmol/g of the polymer of a monomer, which in the case of a normal polycondensation acts mono-functionally, can be added.

Graft polyamides of this type are described in EP 0 345 648 A2, to the disclosure content of which therefore reference is likewise made explicitly.

It is thereby of particular importance that the graft polyamide b) is derived preferably from PA6, PA11 and/or PA12 and has more than 3 arms. The molecular weights of the individual arms must be high enough to form an entanglement network in order not to effect a reduction in the toughness. It is likewise preferred if the relative viscosity (1% in H₂SO₄, 23° C.) is <2.2 and a melt viscosity (γ=500/s) <50 Pas 30° C. above the melting temperature. Furthermore, it is important that, in the case of mixtures, the number average and weight average molecular weight of the graft polyamide, determined via gel permeation chromatography (GPC), correspond approximately to the molecular weights of the linear polyamides, and that the graft polyamide makes possible a significant improvement in the flow of the melt. Likewise, it is particularly important that the graft polyamide can be produced readily in polymerisation plants which are common for polyamides. The surface quality of moulded bodies can be measured via the gloss or can be visually assessed.

From a material point of view, the polyamide mixture A) in the case of the semicrystalline linear polyamides a) includes those which for example are selected from PA6, PA66, PA12, PA6T, PA6T12, PA12T, whereas the terephthalic acid (T) could be replaced partially by isophthalic acid (I) or adipinic acid, or mixtures thereof.

Furthermore, the polyamide mixture A) includes an amorphous polyamide c). Preferably, this is selected from PA MACM12, PA PACM12 or copolyamide mixtures thereof, and PA6I, PA MXDI, PA6I/MXDI, whereas isophthalic acid (I) could be replaced partially by terephthalic acid (T) or adipinic acid and MXDA partially by PXDA. It is most particularly preferred that the amorphous polyamide is selected from PA6I/6T and/or PAMXDI/MXDT/6I/6T.

The polyamide mixture A) is thereby constituted such that the components linear polyamide a), graft polyamide b) and amorphous polyamide c) and if necessary carbon black d) together produce 100% by weight.

The polyamide mixture A) thereby contains 0.5-95% by weight of the semicrystalline linear polyamide a) and 5-99% by weight of the branched graft polyamide b) and 0.5-40% by weight of the amorphous polyamide c). The graft polyamide is thereby constituted as explained previously. It is preferred if the polyamide mixture A) contains 0.5-80% by weight of the semicrystalline linear polyamide a) and 15-98.5% by weight of the branched graft polyamide b) and 1-35% by weight of the amorphous polyamide c). It is most particularly preferred if the weight ratios are in the range of 1 to 64.5% by weight for the semicrystalline linear polyamide a) and 18-79.5% by weight for the branched graft polyamide b) and 20-35% by weight for the amorphous polyamide c). In this case, 0.5-2% by weight of carbon black are contained.

In addition to the polyamide mixture A), the moulding material contains 40 to 235 parts, preferably 40 to 150 parts relative to 100 parts of the matrix component of reinforcing materials B). The reinforcing materials B are thereby selected from glass spheres, glass rovings, glass balls, glass powder, polymeric fibres, carbon fibres, metal fibres or minerals such as talc, kaolin, wollastonite, which preferably have low particle sizes, high tendency to dispersion and high aspect ratios. Obviously also mixtures thereof or suitable master batches can be used.

The moulding material contains, in addition to the polyamide mixture A) and the reinforcing material B), commonly known additives C). Additives of this type are for example stabilisers, slip additives, colorants, metal filters, metallic pigments, stamped metal filters, flame retardants, impact modifiers, anti-static agents, conductivity additives, anti-fogging agents, optical brighteners, flavours, etc.

The moulding material according to the invention displays inter alia an improved melt flow.

By means of the improved melt flow and by means of the reduced crystallisation rate, optically high-grade moulded articles can be produced in larger dimensions. The moulded articles have an outstanding surface quality, expressed by the surface gloss at an angle of 60°, greater than 75. A particular advantage of products with very smooth surfaces, produced from the moulding material according to the invention, is displayed in an outstanding capacity for metallisation according to electroplating, lamination and vapour-deposition methods and a likewise outstanding capacity for painting. Furthermore, high-grade products can be obtained from the moulding material according to the invention by using internal gas pressure (GIT) or internal water pressure techniques.

Due to the high reinforcement proportion of the moulding material according to the invention, highly rigid end products can be produced.

For producing the moulding material according to the invention, normal polymerisation plants can be used for the production of polyamides, and for the production of the mixtures, kneaders and/or single, preferably twin-screw extruders, which contain suitable conveying and kneading elements. Preferably, the matrix components and all the additional materials/additives are dosed into the feeding zone of the extruder and the reinforcing materials are introduced and mixed via side feeders, as near as possible to the discharge nozzle. Suitable melt temperatures are between 230° C. and 300° C. Optionally, individual additives can also be used in the form of suitable master batch granulates or as compactates.

The production of the moulded articles, semi-finished articles, extrudates or hollow bodies is effected in normal commercial machines, the suitable processing temperatures being between 250° C. and 300° C. During processing, optionally individual components in the form of master batch granulates or compactates, can be added directly in the processing machine.

During the production of the graft polyamides and the linear polyamides, suitable regulators can be added in order to obtain the viscosity in the desired range. Monoamines or monocarboxylic acids are thereby preferably used. Regulators such as 4-amino-2,2,6,6-tetraalkylopiperidine or 2,6-dialkylphenols with methylamine or carboxyl groups or types of regulator, which contain one or more of these groups, are particularly preferred. Suitable additive quantities are 0.5 to 5% by mol relative to the used lactam or diamine quantity.

Furthermore, catalytically effective compounds based on phosphorous compounds, such as for example hypo-phosphorous acid, phosphorous acid or phosphoric acid, can be added in quantities of 10 to 500 ppm to the polycondensation batch, and suitable antioxidants, such as sterically hindered hydroxyphenols or HALS-stabilisers, in quantities of 0.05-0.5% by weight.

In order to prevent foamformation during the polymerisation or polycondensation process, suitable defoamers on silicon or silicon derivatives can be added to the polymerisation batch, preferably in the form of stable aqueous emulsions with added silicon dioxide in concentrations of 10 to 500 ppm.

A further variant consists in the addition of layered silicates, such as for example montmorillonite, bentonite or mica, preferably with high aspect ratios, which are added directly during the extrusion of the moulding material and which can be present in the end product in exfoliated form.

The polymerisation or polycondensation batch can optionally contain suitable separation agents and slip additives, such as for example fatty acid esters, waxes or fatty acid amides.

### EXAMPLES

The following examples are intended to explain the invention without restricting it.

Measurements of the properties

The properties with the designation “cond” were measured on conditioned test bodies, the properties with the designation “dry” were measured on dry test bodies. The conditioning was implemented according to ISO 1110.

The measurements of the thermal data were implemented on dry granules (120° C./24 h) with a Perkin Elmer DSC apparatus with heating rates of 20° C./minute and cooling rates of 5° C./minute. The melting temperature was measured according to ISO 3146-C. The crystallisation temperature, crystallisation enthalpy and crystallisation rate were determined in the first cooling cycle. In order to determine the glass transition temperature (Tg) the sample was heated to approximately Tg+20° C., quenched and measured in a second heating cycle (20° C./min).

The mechanical properties, e-modulus, tensile strength and tensile elongation of break were measured by tensile tests on standard test bodies according to ISO 527.

The impact strength and notch-impact strength were determined according to Charpy at 23° C. according to ISO 179eU and ISO 179eA.

The heat deflection temperatures (HDT A and HDT C) were measured according to ISO 75.

The flow lengths were determined in a spiral form 1.5×10 mm at 290° C. melt temperature, 100° C. moulding temperature and 1,000 bar.

The gloss measurements were determined with a Lange colour measuring apparatus (Color-Pen) on colour plates (CP) with 3 mm thickness.

Materials used:
Grilon A28 (Co. EMS-CHEMIE AG/CH), a linear, partially crystalline PA6 with a rel. viscosity (1% in 98% H2SO4 23° C.) of 2.81
Grilon A23 (Co. EMS-CHEMIE AG/CH), a linear, partially crystalline PA6 with a relative viscosity (1% in 98% H2SO4 23° C.) of 2.44
Grivory G21 (Co. EMS-CHEMIE AG/CH), an amorphous copolyamide (PA6I/6T)
glass fibres of the Co. Vetrotex
PA6 carbon black masterbatch (Co. EMS-CHEMIE AG/CH) with 25% carbon black proportion for example: Black Pearl 880 (Co. Cabot)
and normal additives of different origin for polyamides.

In addition, a branched polyamide 6 (PA6v), according to EP 0 409 115, is used for the branched graft polyamide essential for the invention, which is produced as follows.

1,737 g SMA 1,000 (oligomeric styrene maleinic acid anhydride copolymer, Mn˜1,000 g/mol with ˜7-8 maleinic acid anhydride units; Co. Atofina) were filled into a 130 l vessel with 40909.5 g caprolactam, 2353.5 g tridecylamine and 18 l water, heated to 265° C. until a pressure of 22 bar was produced, and maintained at this pressure for 5 h. Thereafter the material was cooled to 260° C. and the system pressure during 6 h reduced to normal pressure. The branched PA6 was discharged, granulated, extracted with water in order to remove residual caprolactam and oligomer components and dried.

The branched PA6 (PA6v) has the following properties (Table 1) in comparison to Grilon A23.

TABLE 1
PA6v properties

| | | Grilon |
|---|---|---|
| Property | PA6v | A23 |
| Rel. viscosity (1% in H2SO4 23° C.) | 1.87 | 2.44 |
| MVI (275° C./2.16 kg) [ml/10 min] | 715 | |
| MVI (275° C./5.00 kg) [ml/10 min] | | ≦280 |
| H2O-extract [%] | <0.5 | <0.5 |
| Mₙ (GPC:PS standard) [g/mol] | 11800 | 14500 |
| M_{w} (GPC:PS standard) [g/mol] | 22200 | 29000 |
| M_{w}/Mₙ | 1.88 | 2 |
| Shear viscosity 250° C. 100/s [Pa s] | 17 | 192 |
| Shear viscosity 250° C. 500/s [Pa s] | 16 | 159 |
| Shear viscosity 250° C. 2100/s [Pa s] | 15 | 100 |
| Shear viscosity 270° C. 100/s [Pa s] | 11 | 121 |
| Shear viscosity 270° C. 500/s [Pa s] | 11 | 113 |
| Shear viscosity 270° C. 2,100/s [Pa s] | 11 | 77 |

Production of the examples (E1-E4) and the comparison examples (CE1-CE3):

In a ZSK25 twin-screw extruder (Co. Werner & Pfleiderer/D), the components according to Table 2 were extruded as follows with an increasing cylinder temperature of at most 260° C. in that the polyamide mixture with additives was introduced into the feed at 100° C. and the glass fibres were fed via a side feeder (5-6 zones after the feed) into the melt. The melt strand was cooled in a water bath, granulated and dried.

The thus-produced moulding materials and moulded articles produced therefrom by means of injection moulding have the properties cited in Table 3.

TABLE 2
Composition of the moulding materials

| Variant | CE1 | CE2 | E1 | E2 | E3 | E4 | E5 | E6 |
|---|---|---|---|---|---|---|---|---|
| Grilon | 47.8 | | | | | | | |
| A28 | | | | | | | | |
| Grilon | | 47.8 | | 23.9 | 38.2 | 25.4 | 15.8 | |
| A23 | | | | | | | | |
| PA6v | | | 47.8 | 23.9 | 9.6 | 6.2 | 15.8 | 31.6 |
| Grivory | | | | | | 16.2 | 16.2 | 16.2 |
| G21 | | | | | | | | |
| GF | 50 | 50 | 50 | 50 | 50 | 50 | 50 | 50 |
| MB | 1.5 | 1.5 | 1.5 | 1.5 | 1.5 | 1.5 | 1.6 | 1.6 |
| Addi- | 0.7 | 0.7 | 0.7 | 0.7 | 0.7 | 0.7 | 0.6 | 0.7 |
| tives | | | | | | | | |

TABLE 3
Properties of the moulding materials

| | CE1 | CE2 | E1 | E2 | E3 | E4 | E5 | E6 |
|---|---|---|---|---|---|---|---|---|
| Flow length/mm | 210 | 260 | 480 | 360 | 310 | 280 | 300 | 340 |
| MVI (275° C./5 kg)/ml/10 min | 20 | 45 | 152 | 92 | 72 | 40 | 58 | 74 |
| Rel. viscosity (0.5% m-cresol 23° C.) | 1.87 | 1.71 | 1.47 | 1.56 | 1.60 | 1.55 | 1.50 | 1.46 |
| E modulus dry/MPa | 15500 | 16500 | 16000 | 15500 | 15500 | 15500 | 15700 | 15500 |
| E modulus Cond./MPa | 9000 | 9500 | 12000 | 11000 | 11000 | 14200 | 14800 | 15000 |
| Fr. str. dry/MPa | 215 | 225 | 215 | 220 | 220 | 220 | 210 | 215 |
| Fr. str. cond./MPa | 140 | 120 | 145 | 145 | 120 | 180 | 180 | 160 |
| Tensile elongation at break, dry/% | 3.0 | 3.0 | 2.5 | 2.5 | 2.5 | 2.5 | 2.2 | 2.4 |
| Tensile elongation at break, cond./%. | 5.5 | 5.0 | 3.5 | 3.5 | 4.0 | 2.8 | 2.2 | 2.4 |
| Impact strength 23° C. dry (Charpy)/kJ/m² | 68 | 76 | 74 | 77 | 74 | 82 | 79 | 71 |
| Impact strength 23° C. cond. (Charpy)/kJ/m² | 71 | 79 | 75 | 74 | 76 | 70 | 74 | 69 |
| Notch-impact strength dry (Charpy)/kJ/m² | 11.4 | 13.5 | 13.7 | 12.8 | 13.6 | 13.1 | 13.1 | 13.6 |
| Notch-impact strength cond. (Charpy)/kJ/m² | 17.2 | 18.8 | 14.4 | 18.0 | 17.6 | 12.3 | 13.6 | 12.9 |
| Gloss 60° C. dry | 65 | 71 | 74 | 75 | 72 | 80 | 79 | 80 |
| Gloss 60° C. cond. | 61 | 69 | 74 | 74 | 72 | 81 | | |
| Gloss 20° C. dry | 27 | 31 | 34 | 35 | 34 | 37 | 36 | 37 |
| Gloss 20° C. cond. | 23 | 29 | 39 | 35 | 33 | 38 | | |
| HDT A | 205 | 205 | 214 | 211 | 210 | 190 | 188 | 187 |
| HDT C | 130 | 170 | 185 | 165 | 170 | 110 | 101 | 99 |
| Tg | 48 | 48 | | | | 65 | 67 | 67 |

Shear viscosity 290° C. at different shear rates

| | | | | |
|---|---|---|---|---|
| 50/s [Pa s] | 668 | 225 | 131 | 144 |
| 100/s [Pa s] | 517 | 200 | 129 | 114 |
| 200/s [Pa s] | 387 | 186 | 127 | 109 |
| 500/s [Pa s] | 252 | 162 | 113 | 106 |
| 800/s [Pa s] | 198 | 141 | 98 | 96 |
| 1000/s [Pa s] | 176 | 129 | 89 | 87 |
| 2500/s [Pa s] | 104 | 72 | 48 | 41 |

1-17. (canceled)

18. A Polyamide molding material for highly glossy, rigid polyamide molded bodies containing
A) 100 parts of a polyamide mixture made of
a) 0.5-95% by weight of a semicrystalline linear polyamide,
b) 5-99% by weight of a branched graft polyamide
b.1.) made of a styrene maleinimide basic structure of the general formula 1 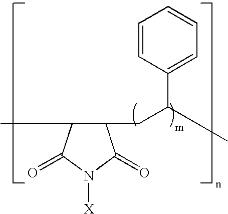
m standing for 1-5 and -n for 3-15, and the molecular weight of the basic structure unit being between 600 and 9000 g/mol and polyamine acid chains are grafted on at the position X and/or
b.2.) obtained via hydrolytic polymerization of amino acids and/or lactams as basic building blocks, where components with a branching effect being added to the melt of the basic building blocks in the following compositions:
b.2.1.) 5-150 μmol/g of the polymer of an at least tri-functional monomer comprising an amine or a carboxylic acid, and
b.2.2.) 2-100 μmol/g of the polymer of an at least bi-functional monomer comprising a carboxylic acid, if b.2.1.) is an amine, or comprising an amine, if b.2.1.) is a carboxylic acid,
c) 0.5-40% by weight of an amorphous polyamide and
d) 0-2% by weight of carbon black, a+b+c+d together producing 100% by weight and
B) 40-235 parts reinforcing materials and
C) additives normal for polyamide molding materials.

19. The polyamide molding material according to claim 18, wherein the polyamide mixture A) contains 0.5-80% by weight of the semicrystalline linear polyamide a), 15-98.5% by weight of the branched graft polyamide b), 1-35% by weight of amorphous polyamide c) and 0-2% by weight of carbon black d).

20. The polyamide molding material according to claim 19, wherein the polyamide mixture contains 1-64.5% by weight of the semicrystalline linear polyamide a), 18-79.5% by weight of the branched graft polyamide b), 20-35% by weight of amorphous polyamide c) and 0.5-2% by weight of carbon black d).

21. The polyamide molding material according to claim 18, wherein it has, at processing temperatures, melt viscosities with shear rates of γ=200/s<300 Pas and at γ=1000 s<150 Pas.

22. The polyamide molding material according to claim 18, wherein the semicrystalline linear polyamide a) is selected from PA6, PA66, PA12, PA6T, PA6T12, PA12T, whereas the terephthalic acid (T) could be replaced partially by isophthalic acid (I) or adipinic acid or mixtures thereof.

23. The polyamide molding material according to claim 18, wherein graft polyamides b) are used, which are derived from PA6, PA11, PA12 and have more than 3 arms.

24. The polyamide molding material according to claim 18, wherein the graft polyamides b) have a relative viscosity (1% in H2S04, 23° C.)<2.2 and a melt viscosity (γ=500/s)<50 Pas 30° C. above the melting temperature.

25. The polyamide molding material according to claim 24, wherein the graft polyamide b) contains inherent slip additives.

26. The polyamide molding material according to claim 18, wherein the polyamides b) have a molecular weight distribution (GPC/standard polystyrene) which corresponds approximately to the distribution of the semicrystalline polyamide a).

27. The polyamide molding material according to claim 18, wherein the amorphous polyamide c) is selected from PA MACM12, PA PACM12, or mixtures/copolyamides thereof and PA61, PAMXDI, PA 6I/MXDI, whereas isophthalic acid (I) could be replaced partially by terephthalic acid (T) or adipinic acid and MXDA partially by PXDA.

28. The polyamide molding material according to claim 27, wherein the amorphous polyamide c) is selected from PA6I/6T and or PAMXDI/MXDT/61/6T.

29. The polyamide molding material according to claim 18, wherein the reinforcing materials B) are selected from glass fibers, carbon fibers, minerals such as talc, mica, kaolin, wollastonite, nanocomposites, whiskers and further reinforcing materials which are common for polyamide or mixtures thereof.

30. The polyamide molding material according to claim 18, wherein the polyamide molding material A) contains common additives C).

31. The polyamide molding material according to claim 13, wherein the additives C) are selected from impact strength modifiers, UV-heat- and processing stabilizers and slip additives which can also be contained inherently in the graft polyamide.

32. The molded articles produced with molding materials according to claim 18, wherein the molded articles have an outstanding surface quality, expressed by the surface gloss at an angle of 60°, greater than 75.

33. A method of producing a molded article comprising injection molding, extrusion, extrusion blow-molding, GIT, WIT, micro-injection molding, injection blowing, pultrusion or deep drawing.

34. The polyamide molding material according to claim 25, wherein the slip additives comprise long-chained n-alkylenes.
